(19) United States
(12) Patent Application Publication
(10) Pub. No.: US 2007/0124404 A1
(43) Pub. Date: May 31, 2007

(54) Recurring message system and method

(75) Inventor: Adam Thomas Gillespie, San Diego, CA (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 11/607,746

(22) Filed: Nov. 30, 2006

Related U.S. Application Data
(60) Provisional application No. 60/741,533, filed on Nov. 30, 2005.

(51) Int. Cl. G06F 15/16

(52) U.S. Cl. 709/206

(57) ABSTRACT

In a preferred embodiment, a recurring message system and method allows a business user or layperson user to send emails at regular intervals based on rules the users have created. This feature can be implemented in many different ways. For instance, the user may utilize the recurring message system and method to send annual “Happy Birthday” emails. Moreover, the user may utilize the recurring message system and method to work integrally with more complex applications that work in conjunction with other email message systems, email campaign managers, and subscriber list systems. It will be evident to one of ordinary skill in the art that the user could use the recurring message feature with an email campaign system or any of a variety of software programs that work with email. Furthermore, the user could use the recurring messages to send a special offer to customers who have not made a purchase in a predetermined number of days.

### RELATED APPLICATIONS

This application claims the benefit of U.S. Provisional Application No. 60/741,533 filed 30 Nov. 2005, entitled “Recurring Messages,” which is incorporated herein by reference.

This application is related to co-pending:

U.S. patent application Ser. No. 11/______, filed Nov. 30, 2006, entitled “Subscriber List System and Method”;

U.S. patent application Ser. No. 11/______, filed Nov. 30, 2006, entitled “Dynamic Content System and Method”; and

U.S. patent application Ser. No. 11/______, filed Nov. 30, 2006, entitled “Sub Accounts System and Method”, all of which are herein incorporated by reference.

### FIELD OF THE INVENTION

The present invention relates to electronic messaging systems for use on the internet. More particularly, the present invention relates to a system and related tools for recurring messages.

### BACKGROUND OF THE INVENTION

Targeting customers with e-mail marketing is like going on a date. The electronic commerce (e-commerce) company makes the customer comfortable by providing information, and the customer tries to understand what the e-commerce company is all about. If the customer likes the e-commerce company there is a second date, and then eventually marriage.

E-commerce companies love e-mail, and for good reason. Production costs are low; results are immediate. Personalized e-mail are messages that consumers sign up to receive or that companies can target at customers based on their previous purchases. Furthermore, targeted e-mail marketing requires a much bigger investment than simply blasting out untargeted e-mail messages because it involves sophisticated databases and statistical modeling.

Targeted e-mail is also more prone to error. Sending a personalized message to the wrong person can ruin a relationship for life. So can a message that overloads a customer's computer. But as long as the e-commerce company chooses the right words and format, experts agree that talking to customers is not only good for sales but also good for name recognition. Any excuse to interact with your customer is healthy for the brand, and targeted e-mail seems to be one of healthiest direct-marketing ways to build brand equity.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes may be called an email campaign.

Present email campaigns may suffer from difficulties in locating a pool of relevant individuals to be contacted. In a small email campaign, each email sent is critical to the success of the campaign, and needs to be carefully created. In other situations, large numbers of individuals to be contacted may have been found. This may result in increased difficulty in tailoring the large number of required email messages to the individuals for more effective contact.

Furthermore, once an email campaign has been initiated, difficulties in measuring success of the email campaign are presented. Effective ways for determining whether email recipients have received email from the email campaign have been sought. Also, effective ways for allowing the email recipients to provide feedback have also been sought. It is desirable for the email recipients to be able to respond with feedback, and for the quantity and content of the responses to be monitored and tracked. Furthermore, conducting advanced database search queries, then saving and managing these searches automatically is desirable as well.

Respecting subscribers to an email is also important. A message that's too focused risks missing out on impulse or crossover buys. According to a recent survey by Return Path, the number of consumers who are reporting opt-in email as spam to their Internet Service Provider (ISP) is up from 23.4% at the end of 2004 to nearly 34% at the end of 2005. The top reasons cited for the increase are lack of content relevancy and ratcheting up frequency beyond subscriber expectations. Moreover, according to a new Hostway survey, 70% of consumers said they would not purchase from websites that committed these pet peeves: pop-up advertising, registration log-on pages, software installation, and slow-loading pages. In addition, there is powerful evidence citing how effective email is when driving traffic to an online sale. In a recent Email Insider report, retailers who used email to promote post-holiday sales saw traffic increases of up to 700% above pre-holiday numbers.

Email deliverability will continue to be a major issue, and there are several deliverability challenges. Some, like authentication methods and challenge-response functionality, will be addressable by meeting technological specifications. But the most important factors affecting deliverability will continue to be reputation and respectful sending practices.

Furthermore, e-marketers' use of segmentation strategies and testing will become increasingly sophisticated. Marketers are getting smarter, and the technology is, too. Upcoming advances in email functionality like easier-to-use dynamic content, more robust testing capabilities, and deeper integration with web analytics providers will give businesses even more actionable information to drive sales and build relationships.

Additionally, there is a right and wrong way to build a list. A list is basically a database of subscribers. If a business wants to build an email marketing program, the best thing is not to purchase or borrow a list. Otherwise, they will be reported as a spammer. The best, most effective way to obtain a good list is to build it from the ground up. Building a database doesn't have to be difficult. In fact, it is one of the best ways to streamline marketing strategy to deliver measurable returns. In growing a quality permission-based list, the website is the best and most obvious place to build a list. If someone is surfing on the website, the business has a stellar opportunity to transform a web user from an interested party to a loyal patron. Usually there will be some link on the website that asks users to “Register Now” or “Subscribe Today” for a free e-newsletter, for more information, or for exclusive sales, offers and promotions. A survey page that is easy to fill out (name and email address are most important) is the next step. This information can then be used in a database.

The most time honored marketing method is word of mouth. Accordingly, using the current database to tell their friends about the business is a proven way to grow list. Using forward-to-a-friend and refer-a-friend tools, the audience will grow exponentially. These tools coupled with creative promotions such as special offers or drawings for those who refer friends, can build the subscriber base even more. But, as with any email marketing method, it must be used mindfully, employing permission-based methods only.

Great lists, like great buildings, are not built overnight. It takes time, often a few years, to grow a list that delivers big returns. A slowly built list ensures that users grow a community of patrons who rarely opt out. Email marketing campaigns are best implemented when integrated with and supported by other marketing efforts. That means the email marketing strategy should be part of printed collateral, in store and on-location promotions, advertising and trade show booth promotions. Every piece of paper about the business should include a link to the website and email subscription information. The present invention allows businesses and users to send recurring messages based on rules the business and users create on their own.

The present invention provides a solution to these needs and other problems, and offers other advantages over the prior art.

### BRIEF SUMMARY OF THE INVENTION

The present invention is related to a software module that solves the above-mentioned problems. In accordance with one embodiment of the invention, a computerized messaging system for use on the internet or other network is described. In a preferred embodiment, a recurring message system and method allows a user to send emails at regular intervals based on rules the user has created. This feature can be implemented in many different ways. For instance, the user may utilize the recurring message system and method to send annual “Happy Birthday” emails. Moreover, the user may utilize the recurring message system and method to work integrally with more complex applications that work in conjunction with other email message systems. It will be evident to one of ordinary skill in the art that the user could use the recurring message feature with an email campaign system or any of a variety of software programs that work with email. Furthermore, the user could use recurring messages to send a special offer to customers who have not made a purchase in a predetermined number of days.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates a screen shot of the beginning page and toolbar for recurring message system and method.

FIG. 2 illustrates the recurring message creation page.

FIG. 3 illustrates another view of the recurring message creation page.

FIG. 4 illustrates another view of the recurring message creation page.

FIG. 5 illustrates another view of the recurring message creation page.

FIG. 6 illustrates another view of the recurring message creation page, in particular the scheduling menu.

FIG. 7 illustrates the view of FIG. 6, and further includes a popup calendar.

FIG. 8 shows a window for choosing recipients in recurring message system and method.

FIG. 9 shows the details of the content of a newly created recurring message.

FIG. 10 shows a summary of recurring messages for editing and deleting.

FIG. 11 shows the form for content on a website.

FIG. 12 shows a summary of recurring messages after message retrieval.

FIG. 13 shows a send message statistics page.

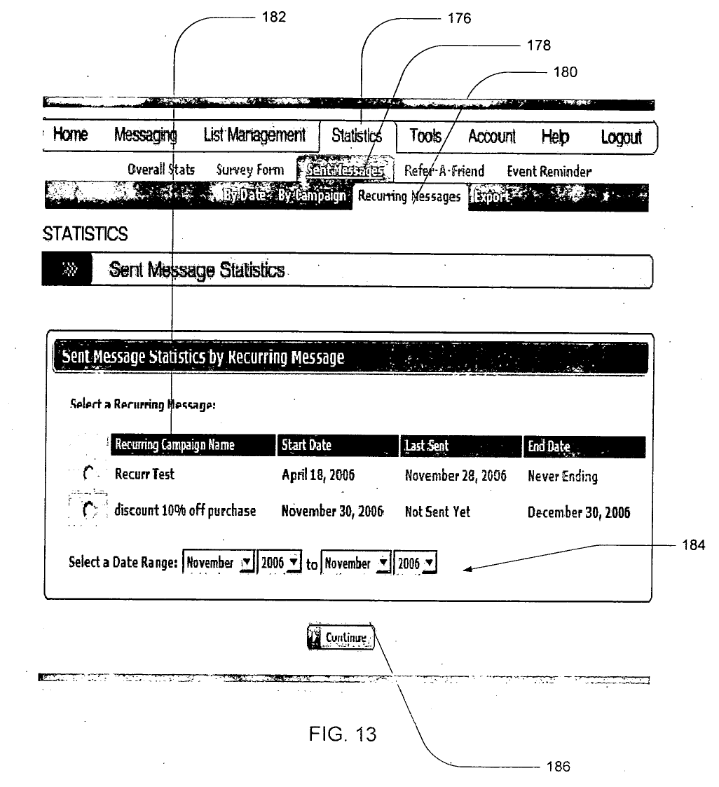

### DETAILED DESCRIPTION

In a preferred embodiment, a recurring message system and method allows a user to send emails at regular intervals based on rules the user has created. This software module may be implemented in many different ways. For instance, the user may utilize the recurring message system and method to send out annual “Happy Birthday” emails. Moreover, the user may utilize the recurring message system and method to work integrally with more complex applications that work in conjunction with other email message systems. The recurring message system and method may be utilized by a variety of business and layperson users.

It will be evident to one of ordinary skill in the art that the user could use the recurring message feature with an email campaign system or any of a variety of software programs and/or modules that work with email. Furthermore, the user could use email to send a special offer to customers who have not made a purchase in a predetermined number of days. Accordingly, customer demographics, preference settings, and shopping behaviors may be utilized in determining the types and schedules of recurring messaging leaving the system. This customer profile information may be collected in a database which may work integrally with an email campaign or subscriber list system.

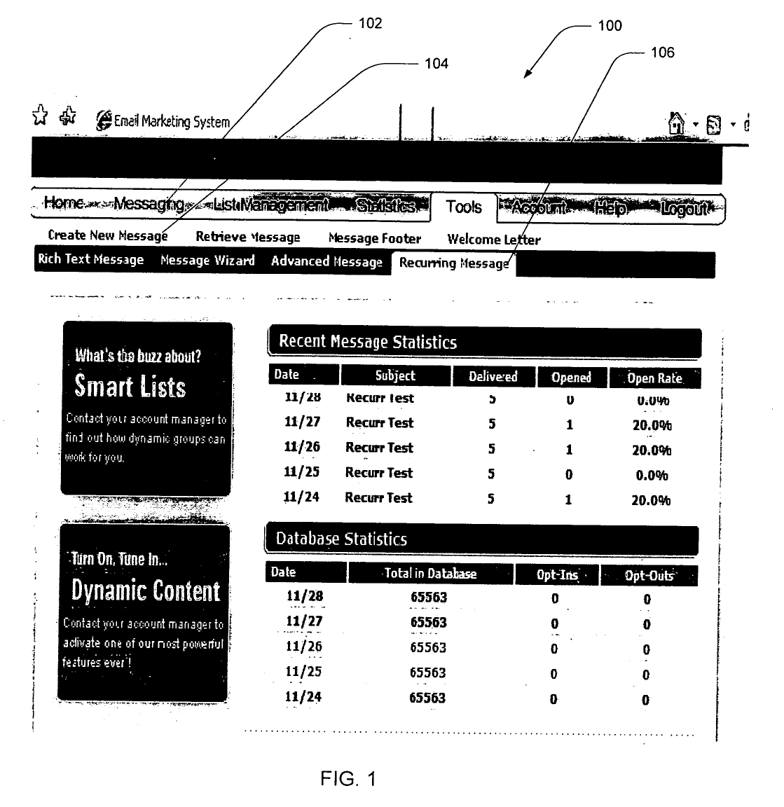

FIG. 1 shows the first step in creating a recurring message. In the top navigation bar 100, the user mouses over “messaging” 102 to “create new message” 104, then clicks the recurring message link 106. The process for creating a recurring message is basically the same as it is for creating a standard one. In this example, the message will be an offer for 10% off any purchase. The user may set the rules in this message to send to a few or all subscribers. It will be evident to one of ordinary skill in the art that the user may choose certain subscribers from a collected email list or database. Subscribers may be customers who have joined a business email list. It will be evident to one of ordinary skill in the art that the user may be a business that works with an email marketing business or group. Also, the email lists may be used in an email marketing or messaging campaign and be based on customer demographics, preference settings, and shopping behaviors.

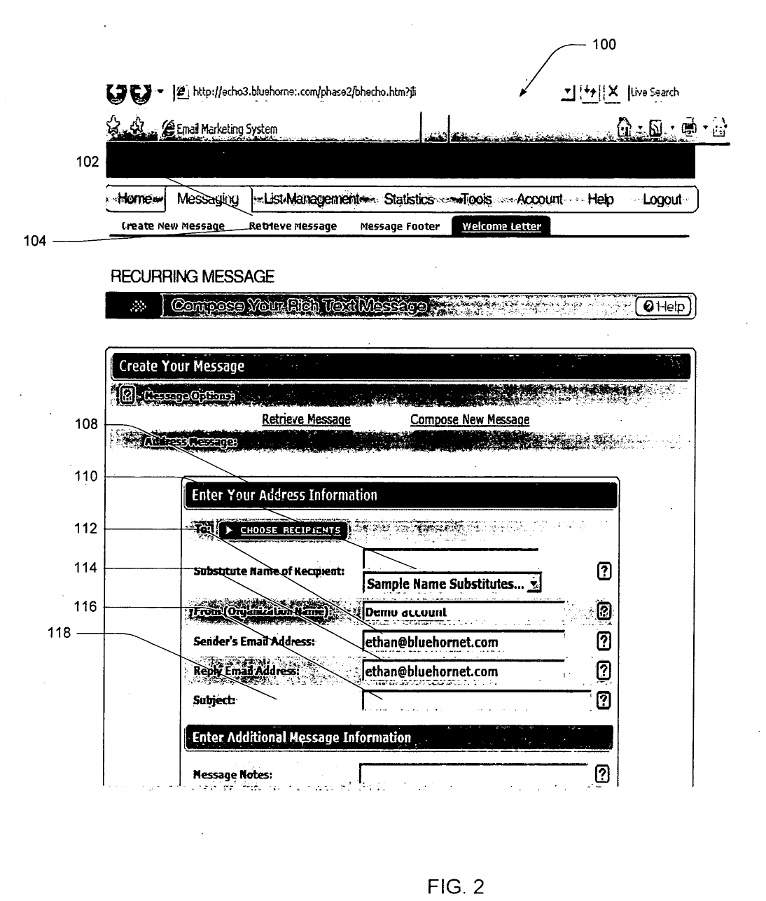

FIGS. 2 through 7 illustrate a page a user may see when creating a recurring message. It will be understood that FIGS. 2 through 7 are scrolled down views of the same web page. FIG. 2 shows the page for creating a recurring message. The user will add the information requested in the form under “Enter Your address Information” 108. The information requested may be name of recipients 110, organization name 112, sender's email address 114, reply email address 116, and subject 118.

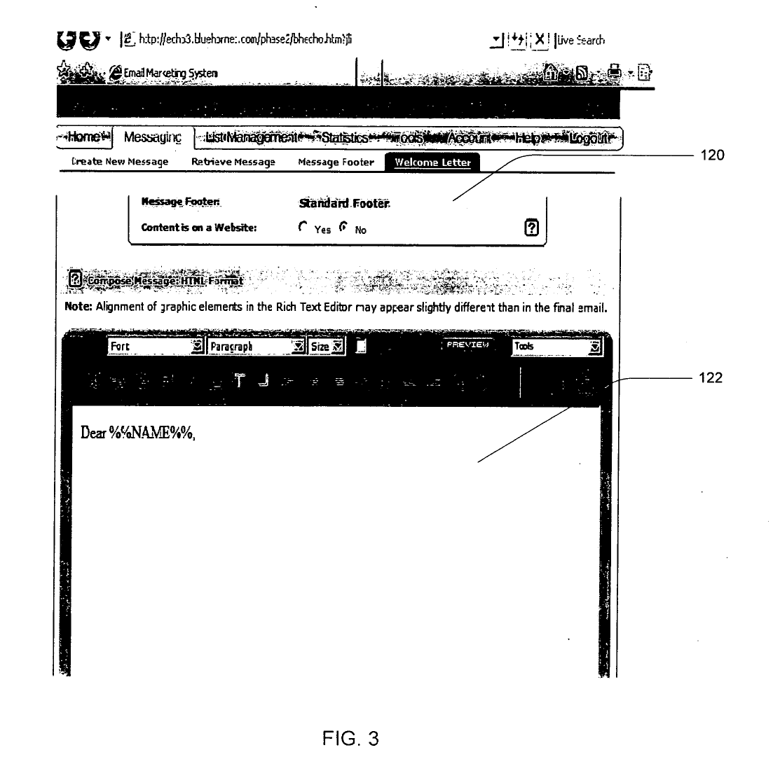

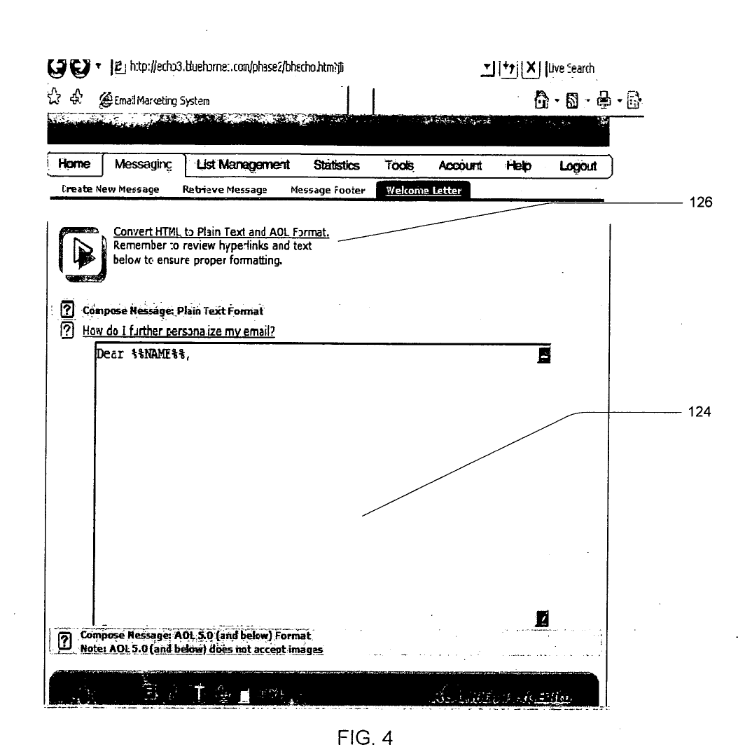

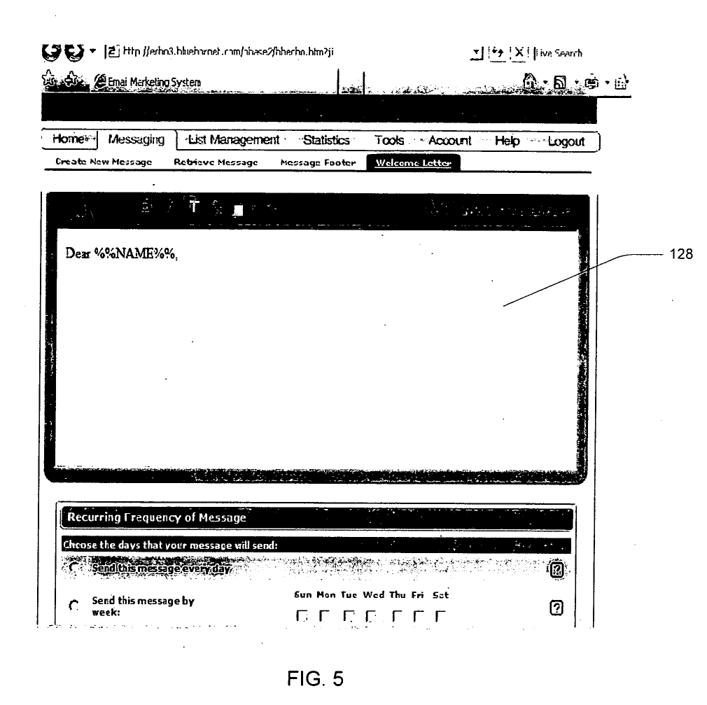

FIG. 3 illustrates another view of the recurring message creation page. Here the user may request that a message footer 120 be placed in the message. It will be understood that the message footer 120 may be based on customer profile data, demographic information, preference settings, and shopping behavior. This data may be determined and collected from subscriber lists through email campaign management systems. Furthermore, the user can add text to compose the message. The user may edit the text with the options shown in the compose message window 122. In FIG. 4 a plain text format 124 for composing a message is shown. Additionally, the user may convert HTML to Plain Text and American Online (AOL) Format and the link 126 is there to supply the user with further information on this matter. Accordingly, an AOL rich text editor 128 is shown in FIG. 5.

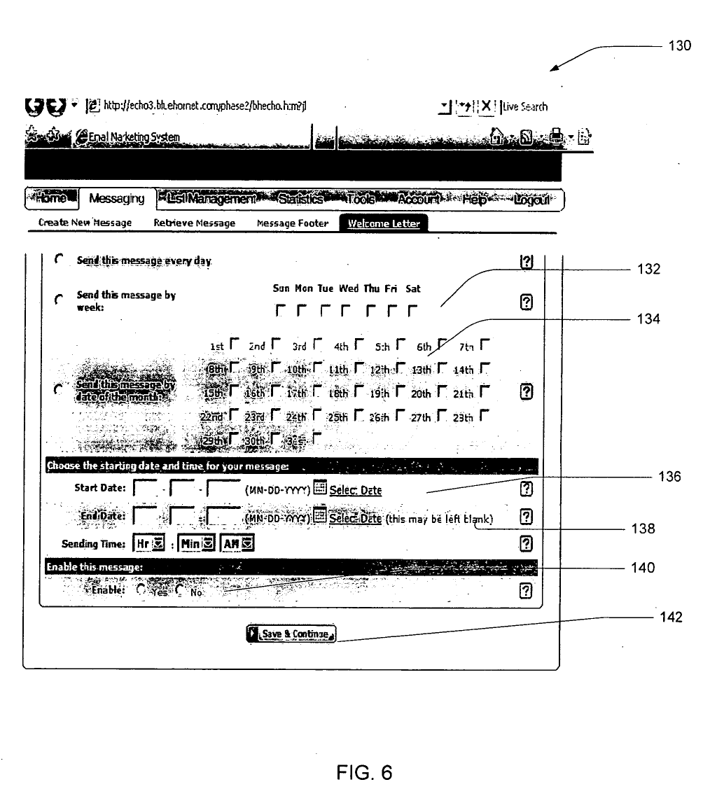

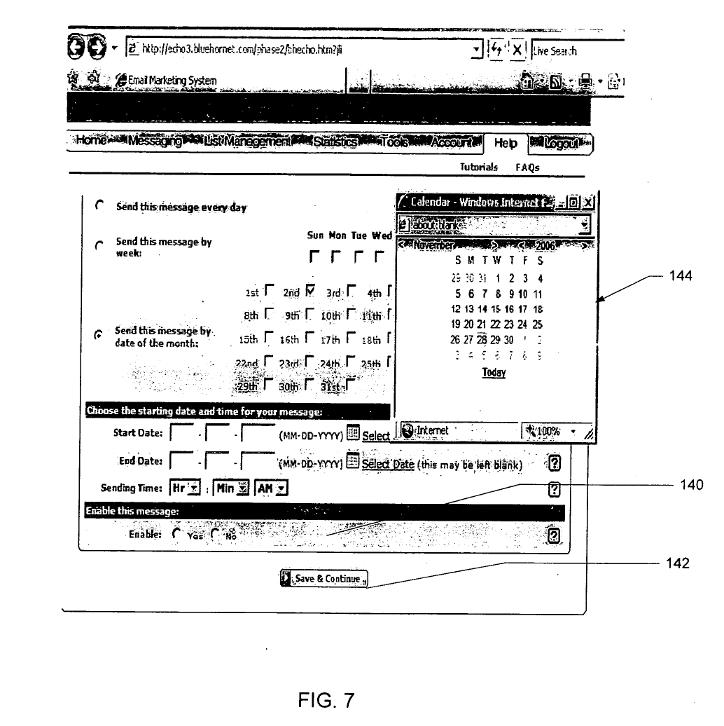

Referring now to FIG. 6, the user can create a schedule 130 for the recurring messages. For example, the user may wish to send a discount to customers who have not made a purchase in sixty days. If every subscriber is on a different sales cycle, the message will need to go out every day. Optionally, the user may utilize the software module to send the offer weekly 132 or monthly 134. The user then sets the start 136 and end 138 date for the recurring message. If the user wishes the message to recur indefinitely they may leave the end date 138 alone. Once the user is ready they may click “yes” under the “enable this message” tab 140 to begin the process. But if the user would like to do other things the process should be disabled to keep the recurring message from sending immediately. Referring now to FIG. 7, the user may select the start 136 and end 138 dates from a popup calendar 144. When the user has finished they may click “Save and Continue” 142.

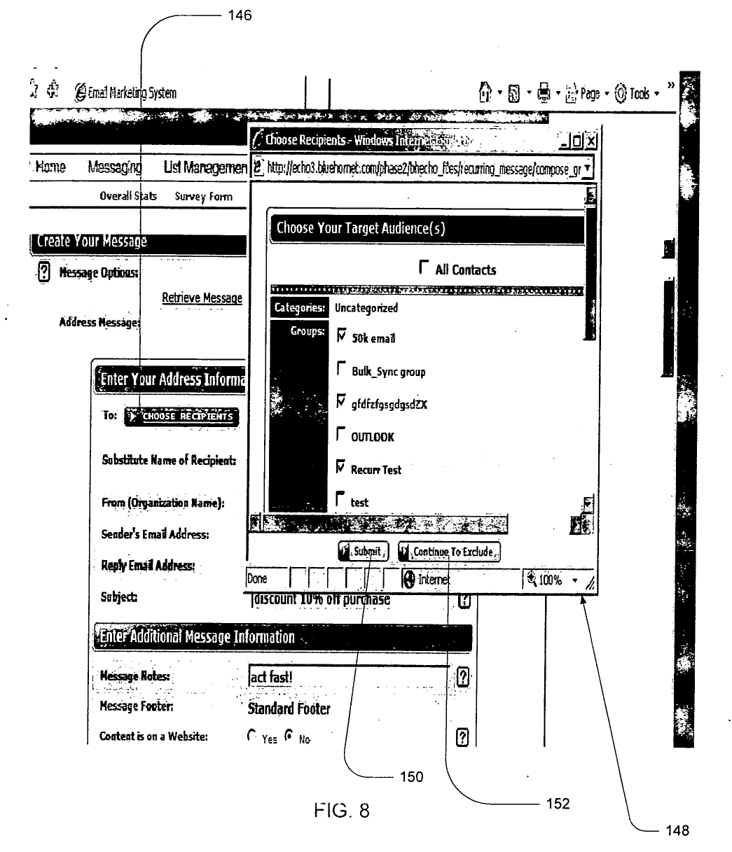

Referring to FIG. 8, the user may select which contacts to send the recurring messages. The user would click “Choose Recipients” 146 to select which groups of subscribers to send the recurring message. A “Choose Your Target Audience” popup window 148 appears. The user may then click “Submit” 150 or “Continue to Exclude” 152. Target audience may be determined through demographic information, preference settings, and shopping behaviors. It will be understood that this customer profile data may be collected via subscriber list systems or email campaign managers.

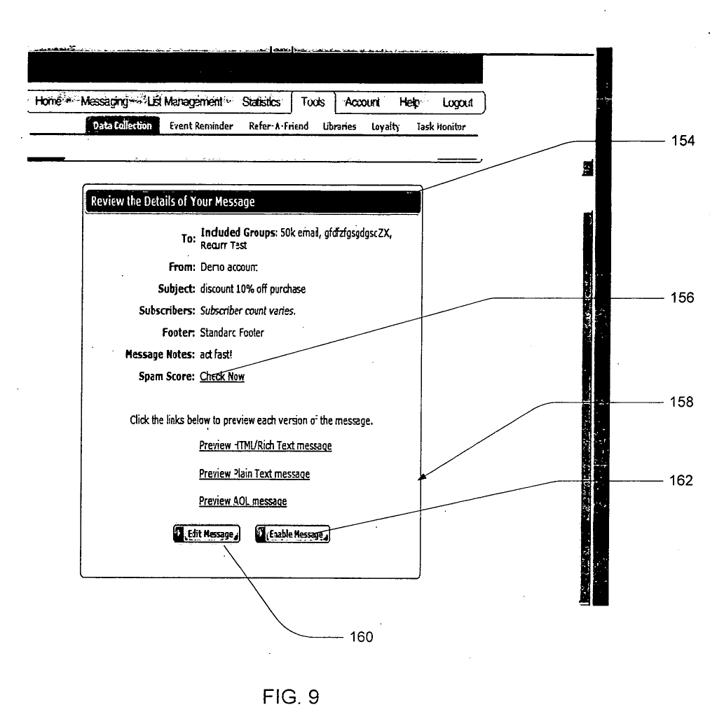

In FIG. 9, the page that appears once the user has clicked “Save and Continue” 142 on FIG. 7 is shown. Here the user may review the details 154 of the recurring messages they have just set up. The user can check the message's spam rating 156 and preview each version 158. If the user needs to change anything they would click “Edit Message” 160 or click “Enable Message” 162 if it is suitable. The user then has successfully created and set the schedule for a recurring message.

### Pulling Recurring Message Content from a Website

In a preferred embodiment, recurring message system and method is a software module that lets the user pull message content from a file hosted on a website. This gives the user the ability to modify email content without having to login to the system.

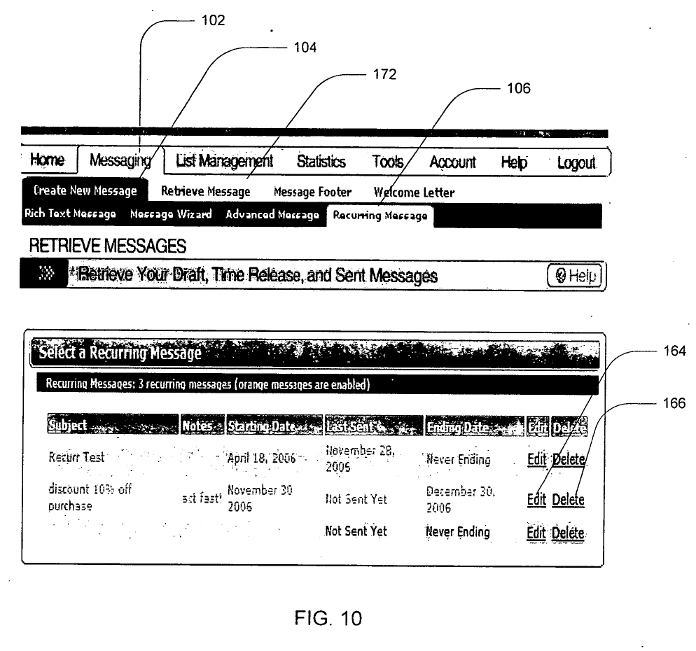

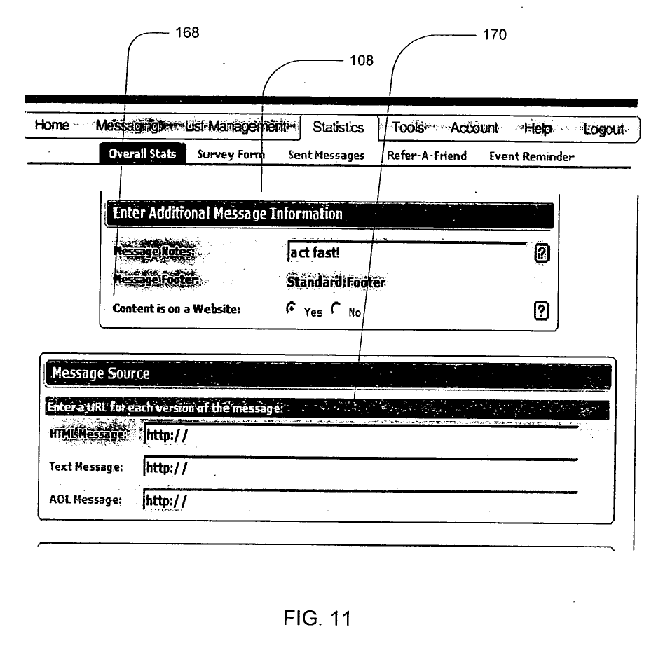

Referring now to FIG. 10, the user mouses over “messaging” 102 and “create new message” 104 then clicks “recurring message” 106. Then the user will click “Edit” 164 under the recurring message they wish to view. In the alternative, the user may click “Delete” 166 to cancel the message. Moving on to FIG. 11, the user can see that below the address information are fields for entering “additional message information” 108. Below two text boxes, the user will see radio buttons for “content on website” 168. After clicking “yes,” the user sees new “message source” table 170 replacing message editors. The user may then add the Uniform Resource Locator (URL) for each version of the content in the recurring message (HTML, text and AOL). After the user has added the URLs and tested the message, they may go back to scheduling a recurrence using the process outlined above on setting up recurring messages.

### Viewing Existing Recurring Messages

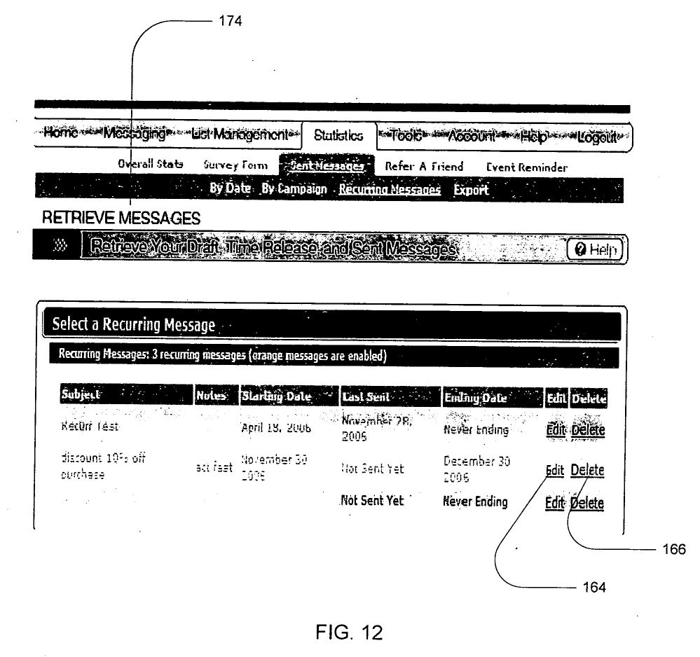

From time to time the user may wish to update the content of an existing recurring message, change its schedule, or perhaps delete it. Referring again to FIG. 10, the user mouses over “messaging” 102 and “new message,” 104 then clicks “recurring message” 106. Next the user clicks the “retrieve message” 172 link in the toolbar 100. Referring now to FIG. 12, the user will see all the existing messages under a “retrieve messages” box 174. The ones that are currently enabled, or active, are noted in bold text. It will be evident to one of ordinary skill in the art that the existing messages may be differentiated in a number of methods. Again, clicking “edit” 164 can make a change to the message or clicking “delete” 166 cancels the message altogether.

### Viewing Statistics for Recurring Messages

In another preferred embodiment of recurring message system and method, the user may check the statistics on the recurring messages at any time. The user mouses over “statistics” 176 and “sent messages,” 178 then clicks “recurring messages” 180. The user will see the existing recurring messages listed by name 182. Conversely the user may select a start date range 184. The user clicks the radio button next to the desired message and then clicks “continue” 186 to view the statistics for the message. These statistics may be utilized to view the status of recurring messages and may be determined through demographic information, preference settings, and shopping behaviors. It will be understood that this customer profile data may be collected via subscriber list systems or email campaign managers.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A computerized recurring message system for use on a network, comprising:
a database having customer profile data where each customer record includes an email address and at least one of: a customer demographic, a preference setting, and a shopping behavior;
a software module operatively configured to utilize business user input to create a rule for sending messages at regular intervals based on the customer profile data; and
an email campaign manager operatively configured to send a personalized message to a customer over the network based on the business user created rule.

2. The recurring message system of claim 1 wherein the rule for sending messages at regular intervals comprises a starting date and an ending date.

3. The recurring message system of claim 1 wherein the rule for sending messages at regular intervals comprises an enabled state.

4. The recurring message system of claim 1 wherein the software module comprises an editor for creating dynamic content for the personalized message.

5. The recurring message system of claim 4 wherein the editor is operatively configured to create dynamic content in a format selected from a group consisting of: plain text, rich text, hypertext markup language, and America Online.

6. The recurring message system of claim 1 wherein the rule for sending messages at regular intervals comprises setting an interval based on one of: a day of week, a time of day, and a day of month.

7. The recurring message system of claim 2 wherein the rule for sending messages at regular intervals comprises a rule based on group membership.

8. The recurring message system of claim 1 wherein the software module is operatively configured to provide statistics to a user related to campaigns having the recurring messages.

9. A method for managing recurring messages for use on a network, comprising steps of:
storing customer profile data where each customer record includes an email address and at least one of: a customer demographic, a preference setting, and a shopping behavior;
utilizing business user input to create a rule for sending messages at regular intervals based on the customer profile data; and
sending the personalized message to a customer over the network based on the business user created rule.

10. The method of claim 9 wherein the utilizing step comprises creating a rule for sending messages at regular intervals with a starting date and an ending date.

11. The method of claim 9 wherein the utilizing step comprises creating a rule for sending messages at regular intervals with an enabled state.

12. The method of claim 9 further comprising a step of creating dynamic content for the personalized message.

13. The method of claim 12 wherein the creating step comprises creating dynamic content in a format selected from a group consisting of: plain text, rich text, hypertext markup language, and America Online.

14. The method of claim 9 the utilizing step comprises creating a rule for sending messages at regular intervals with an interval based on one of: a day of week, a time of day, and a day of month.

15. The method of claim 9 the utilizing step comprises creating a rule for sending messages at regular intervals based on group membership.

16. The method of claim 9 further comprises a step of providing statistics to a user related to campaigns having the recurring messages.
